(19) United States
(12) Patent Application Publication
(10) Pub. No.: US 2023/0095793 A1
(43) Pub. Date: Mar. 30, 2023

(54) Engagement UI for Pages Accessed Using Web Clients

(71) Applicant: ServiceNow, Inc., Santa Clara, CA (US)

(72) Inventors: Mayank Agrawal, Hyderabad (IN); Sarup Paul, Santa Clara, CA (US)

(21) Appl. No.: 17/449,167

(22) Filed: Sep. 28, 2021

(51) Int. Cl. G06F 16/957; G06F 16/958; G06F 40/35; H04L 12/58; G06N 20/00

(52) U.S. Cl. CPC G06F 16/9577; G06F 16/972; G06F 40/35; H04L 51/02; G06N 20/00

(57) ABSTRACT

A system and method for rendering of engagement UI for pages accessed using web clients is provided. The system detects a page of a website or a web application as active or loaded within a web client of a user device. The system further determines a set of attributes associated with the detected page and searches a catalog of actions items based on the determined set of attributes to determine a set of actions items. Thereafter, the system controls the web client of the user device to render an engagement UI on the page and presents the determined set of actions items as UI elements of the engagement

### FIELD

Various embodiments of the disclosure relate to web technology, content personalization, and websites/webpages with interactive user interfaces. More specifically, various embodiments of the disclosure relate to a system and method for rendering of an engagement UI for pages accessed using web clients.

### BACKGROUND

With advancements in web technology, there has been a tremendous rise in various web-based services. It has become easier for owners or service providers associated with websites to engage with users of websites, to track footprints of such users on various pages, and to offer such users with options to explore various services or products offered or promoted on websites and web applications. A user can typically access any website or web application for a variety of reasons. For example, on a subscription-based content streaming application, a user may visit to login or logout, to signup, to purchase a subscription, to make a payment, to renew an existing subscription, to watch content, to browse a catalog of available content, or to raise a ticket associated with any of the several features of the application. Typically, websites or web applications have pages dedicated for offering support for certain common issues. For instance, such pages may provide a login support, a password reset option, a customer care support, and a ticket raising portal. At times, for many of the issues such as streaming issues, payment errors, or issues related to other application-specific features, there are no easily accessible options. Most website or web applications require the users to contact a customer care support to find support for issues that are otherwise not available on the websites or the web applications. In some instances, users have to use search engines to look up relevant resources or support for the issues they may be facing on the websites or the web applications. Without appropriate support, many websites or web applications may face a decline in pages views and application usage, an increased customer churn, and a potential loss in revenue.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for rendering of engagement UI for pages accessed using web clients is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram of an exemplary network environment for rendering of engagement UI for pages accessed using web clients, in accordance with an embodiment of the disclosure.

FIG. 2 depicts a block diagram that illustrates a first set of operations for rendering of engagement UI for pages accessed using web clients, in accordance with an embodiment of the disclosure.

FIG. 3 depicts a block diagram that illustrates a second set of operations for rendering of engagement UI for pages accessed using web clients, in accordance with an embodiment of the disclosure.

FIG. 4 is a diagram that illustrates an exemplary scenario for rendering of an option to view engagement UI for pages accessed using web clients, in accordance with an embodiment of the disclosure.

FIG. 5 is a diagram that illustrates an example dashboard user interface for composing one or more rules for determination of a set of action items, in accordance with an embodiment of the disclosure.

FIG. 6 is a diagram that illustrates an exemplary engagement UI on a payment page of exemplary electronic commerce (e-commerce) website, in accordance with an embodiment of the disclosure.

FIG. 7 is a diagram that illustrates an exemplary engagement UI on a page of exemplary accounting web application, in accordance with an embodiment of the disclosure.

FIG. 8 is a block diagram of a system for rendering of engagement UI for pages accessed using web clients, in accordance with an embodiment of the disclosure.

FIG. 9 is a flowchart that illustrates an exemplary method for rendering of engagement UI for pages accessed using web clients, in accordance with an embodiment of the disclosure.

### DETAILED DESCRIPTION

The following described implementations may be found in a disclosed system and method for rendering an engagement UI for pages accessed using web clients. Traditionally, many websites and web applications display a support window to assist end-users of the websites or the web applications. The support window may be displayed on several pages of the websites or the web applications. For instance, the support window may be chat or a conversational interface with an option to chat with a support member (e.g., a customer care executive) or a chat bot. Other than the option to chat, the support window be displayed on some or all pages of the website or the web-applications with some static actions. In many instances, the support window with the static actions may be displayed, irrespective of page content/context, requirements of a user, or issues faced by the user of the websites or the web applications. On certain pages, such static actions may be helpful to a user. On other pages, such static actions may not be relevant or helpful to the user. For example, an action that helps to assist users in signing up on a content streaming website may be relevant for a homepage section of the website. The same action may not be relevant for a payment page of the website. There is requirement to display an engagement UI which recommends a dynamic set of action items based on a context and/or content of page(s) active or loaded in the web client associated with the user.

The disclosed system may determine a set of attributes associated with the page. Such attributes may determine a context of the page. Based on the determined context of the page, the disclosed system may determine a set of action items that may be contextually related to a product or a service offered by the website or the web application. Thereafter, the disclosed system may render an engagement UI on the page and may present the determined set of actions items as UI elements of the engagement UI. By determining the context, the disclosed system may be able to dynamically present only contextually-relevant action items on each page. For example, if the end-user is on the payment page of the website, then the set of action items may be related to payments and if the end-user is on a product page, then the set of action items may be related to product displayed on the product page. In contrast, traditional approaches only provide static actions, often unassociated with the context of the page. By providing contextually-relevant action items, the end-user may be able to quickly, effectively, and efficiently find solutions to queries, issues, or other needs associated with products/services offered by the website/web application. The disclosed system may help to reduce the burden on the support members of the website or the web application to a certain extent as users may be able to find support for their requirements via the engagement UI.

The disclosed system may determine the set of action items based on a rule-based approach or a more sophisticated machine learning based approach. Each action item of the determined set of action items may be contextually related to the product or the service offered by the website or the web application. In contrast to conventional engagement options, the determined action items may not be limited to merely a chat option, but may include various types of action items, such as a call-to-action (CTA) associated with the product or the service, a greeting, a reminder, an active ticket or a service request, a catalogue item, a knowledge base article, a call request option, a search bar, and a case management guide

Exemplary aspects of the disclosure provide a system that may include a processor. The system may detect a page of a website or a web application as active or loaded within a web client of a user device. The system may further determine a set of attributes associated with the detected page. The system may further search a catalog of actions items based on the determined set of attributes to determine a set of actions items. Each action item of the set of action items may be clickable and contextually related to a product or a service offered by the website or the web application. The system may further control the web client of the user device to render an engagement UI on the page and to present the determined set of actions items as UI elements of the engagement UI.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized, and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways. Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

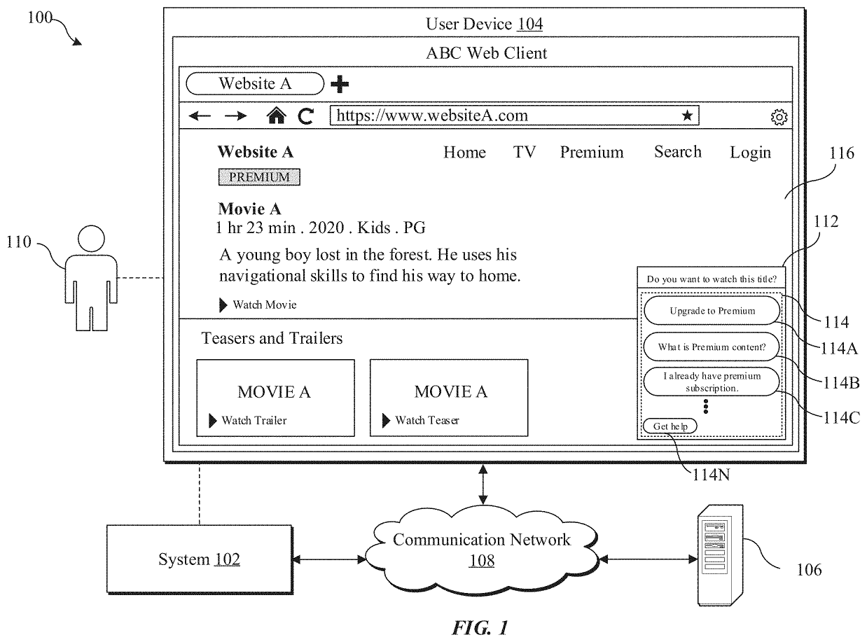

FIG. 1 is a diagram of an exemplary network environment for rendering of engagement UI for pages accessed using web clients, in accordance with an embodiment of the disclosure. With reference to FIG. 1, there is shown a block diagram of a network environment 100. The network environment 100 may include a system 102, a user device 104, and a server 106. The system 102 may be configured to communicate with the user device 104 and the server 106, through a communication network 108. With reference to FIG. 1, there is further shown an end-user 110 and an engagement user interface (UI) 112 displayed on the user device 104. A set of actions items 114 is further shown, for example.

The system 102 may include suitable code, logic, circuitry, and/or interfaces that may be configured to render an engagement UI (such as the engagement UI 112) on a page (such as the page 116) of a website or a web application. The engagement UI 112 may include actions items (such as the set of actions items 114) contextually associated with the page and activities of the end-user 110. Example implementations of the system 102 may include, but are not limited to, a cloud server (public, private, or hybrid), a distributed computing server or a cluster of servers, a Software-as-a-Service (SaaS) application server, an edge computing system that includes a network of distributed compute/edge nodes), a mainframe system, a work-station, a personal computer, or a mobile device.

In an exemplary embodiment, the system 102 may include a frontend subsystem and a backend subsystem. The frontend subsystem may be part of a client-side code or application, executable on user devices, IT terminals, or electronic devices associated with provider of the websites or the web applications. The frontend subsystem may be configured to execute at least one operation on the user device 104 to render the engagement UI 112 and/or the set of action items 114 as UI elements and to allow end-users or customers, IT admins, or website operators to provide inputs. The frontend subsystem may be deployed on several web-clients, such as web browsers, each of which may be associated with a network of user devices (including the user device 104). The backend subsystem may include a server-side application, which may execute operations related to the determination of the set of action items 114 for presentation on the user device 104.

The user device 104 may include suitable logic, circuitry, and interfaces that may be configured to load the page 116 of the website or the web application within a web client of the user device 104. In an embodiment, the user device 104 may be further configured to receive a first input and a second input from the end-user 110. The first input may be associated with running a web client (e.g., a web browser) on the user device 104 and the second input may be associated with a loading of the page 116 of the website or the web application inside the running web client. The user device 104 may be further configured to render the loaded page 116 on a display screen associated with the user device 104. Examples of the user device 104 may include, but are not limited to, a computing device, a smartphone, a mobile computer, a gaming device, a wearable display device (such as an eXtended Reality (XR) device), a mainframe machine, a server, a computer work-station, and/or a consumer electronic (CE) device.

The server 106 may include suitable logic, circuitry, and interfaces, and/or code that may be configured to store a catalog of actions items for each website or web application that uses an engagement UI to present action items to its users. The server 106 may be also configured to train and store a machine learning (ML) model on a task of finding optimal actions items from the catalog of action items for presentation on user devices.

In an embodiment, the server 106 may be configured to store a rule database that may store one or more rules. In another embodiment, the server 106 may be configured to store attributes of the page(s) and a context table that stores such attributes in a defined format. The server 106 may be implemented as a cloud server may execute operations through web applications, cloud applications, HTTP requests, repository operations, file transfer, and the like. Other example implementations of the server 106 may include, but are not limited to, a database server, a file server, a web server, a media server, an application server, a mainframe server, or a cloud computing server.

In at least one embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and system 102 as two separate entities. In certain embodiments, the functionalities of the server 106 can be incorporated in its entirety or at least partially in the server 106, without a departure from the scope of the disclosure.

The communication network 108 may include a communication medium through which the system 102, the user device 104, and the server 106 may communicate with each other. The communication network 108 may include one of a wired connection or a wireless connection. Examples of the communication network 108 may include, but are not limited to, the Internet, a cloud network, a Wireless Fidelity (Wi-Fi) network, a Personal Area Network (PAN), a Local Area Network (LAN), a mobile wireless network (such as 5G New Radio), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), International Mobile Telecommunications-2020 (IMT-2020), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT)® communication protocols.

In operation, the user device 104 may receive a first input. The first input may be associated with execution of a web client on the user device 104. The web client may be a software program that may allow the end-user 110 to locate, access, and display pages of the website or the web application. The web client may locate the page based on an identifier, such as a uniform resource locator (URL) of the website or the web application. As shown in FIG. 1, the first input may be associated with execution of “ABC web client” on the user device 104. Based on the execution of the web client on user device 104, the user device 104 may receive the second input to load (access and display) the page 116 of the website or the web application. As shown in FIG. 1, the second input may be associated with loading of a homepage of the “website A” that may be accessed via the URL “https://www.websiteA.com”.

The system 102 may be configured to detect the page 116 of the website or the web application as active or loaded within the web client of the user device 104. In a multi-tabbed web client, the page 116 may be detected as active if the page 116 is loaded in an active tab of the web client. Based on the detection, the system 102 may determine a set of attributes associated with the detected page. In an embodiment, the set of attributes may be further associated with a user activity on the web client. The set of attributes may be embedded into the page 116 and may include, for example, a URL of the page 116, a geo-location of the end-user 110 accessing the page through the web client of the user device 104, a browsing history on the web client, a title of the page, a heading of the page, a set of Hypertext Markup Language (HTML) tags of the page, one or more user-defined custom attributes, and the like.

The system 102 may be further configured to search the catalog of actions items based on the determined set of attributes to determine a set of action items (such as the set of actions items 114). By way of example, and not limitation, the set of action items may correspond to one or more of a call-to-action (CTA) associated with the product or the service, a greeting, a reminder, an active ticket or a service request, a catalog item, a knowledge base article, a call request option, a search bar, a case management guide, and a chat option to initiate a chat with a support member. The set of action items 114 may include one or more items of the catalog. Each action item of the set of action items 114 may be clickable and may be contextually related to a product or a service offered by the website or the web application.

As shown, for example, the set of actions items 114 may include a first action item 114A, a second action item 114B, a third action item 114C, and an Nth action item 114N. The first action item 114A may be a catalog item, the second action item 114B may be a knowledge base article, the third action item 114C may be a case management guide, and the Nth action item 114N may be a chat option to initiate the chat with the support member.

The system 102 may be further configured to control the web client of the user device 104 to render the engagement UI 112 on the page 116 and present the determined set of actions items as UI elements of the engagement UI 112.

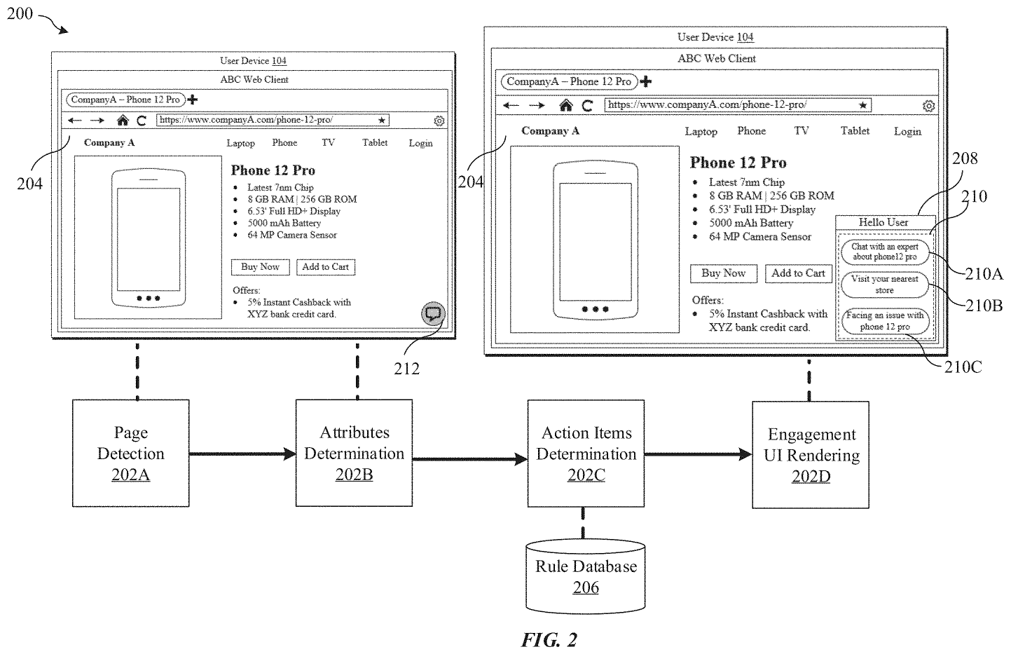

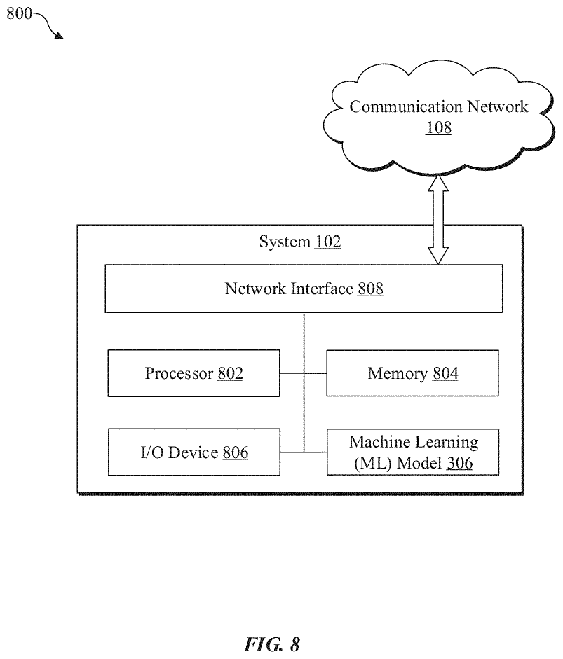

FIG. 2 is a block diagram that illustrates a first set of operations for rendering of engagement UI on pages accessed using web clients, in accordance with an embodiment of the disclosure. FIG. 2 is explained in conjunction with elements from FIG. 1. With reference to FIG. 2, there is shown a block diagram 200 of a set of exemplary operations from 202A to 202D. The exemplary operations illustrated in the block diagram 200 may be performed by any system, such as by the system 102 of FIG. 1 or by a processor 802 of FIG. 8.

At 202A, a page detection operation may be executed. In the page detection operation, the system 102 may be configured to detect a page 204 of the website or the web application as active or loaded within the web client of the user device 104. In a multi-tab web client, the page may be determined as active if the page is loaded and displayed in an active tab of the web client. In an embodiment, the system 102 may transmit a request to the web client of the user device 104 to detect whether the page 204 is loaded or active within the web client of the user device 104. The web client may be configured to transmit a response to the system 102 based on the received request. Based on the response, the system 102 may detect the page 204 of the website or the web application as active or loaded within the web client of the user device 104. As shown, for example, the page 204 of the website “https://www.companyA.com/phone-12-pro/” may be active in the “ABC web client” of the user device 104.

At 202B, an attribute determination operation may be executed. In the attributes determination operation, the system 102 may be configured to determine a set of attributes associated with the detected page 204. In an embodiment, the set of attributes may be embedded into the page 204 and may include, for example, a uniform resource locator (URL) of the page 204, a title of the page 204, a heading of the page 204, a set of Hypertext Markup Language (HTML) tags of the page 204, and one or more user-defined custom attributes. Additionally, the set of attributes may be associated with the web client and may include a geo-location of the end-user 110 accessing the page 204 through the web client of the user device 104 and a browsing history on the web client or one or more web clients installed on the user device 104. In an embodiment, the set of attributes may be embedded by an administrator of the website or the web application.

At 202C, an action items determination operation may be executed. In the action items determination operation, the system 102 may be configured to determine a set of action items 210 to be rendered on an engagement UI 208. To determine the set of action items 210, the system 102 may be configured to search a catalog of action items. The catalog of action items may be searched based on the determined set of attributes. Specifically, the catalog of action items may be searched based on a value of each of the determined set of attributes.

To search the catalog of action items, the system 102 may be configured to generate a context table that may include the determined set of attributes. The context table may include elements of the determined set of attributes embedded in the page 204. Each row of the context table may include a set of values, each of which corresponds to an attribute of the determined set of attributes. By way of example, and not limitation, the end-user 110 visits pages with following URLs:
“https://www.companyA.com/phone-12-pro/”,
“https://www.companyA.com/companyA-tv-4k/”,
“https://www.companyA.com/companyA-tv-4k/specs/”, and
“https://tv.companyA.com/”. An example of the generated context table for such URLs is presented in Table 1:

TABLE 1
Context Table

| | PRODUCT | SECTION | GEO- |
|---|---|---|---|
| BASE URL | URL | PAGE | LOCATION |
| https://www.companyA.com | phone-12-pro | — | USA |
| https://www.companyA.com | companyA- | — | USA |
| | tv-4k | | |
| https://www.companyA.com | companyA- | specs | USA |
| | tv-4k | | |
| https://tv.companyA.com | — | — | USA |

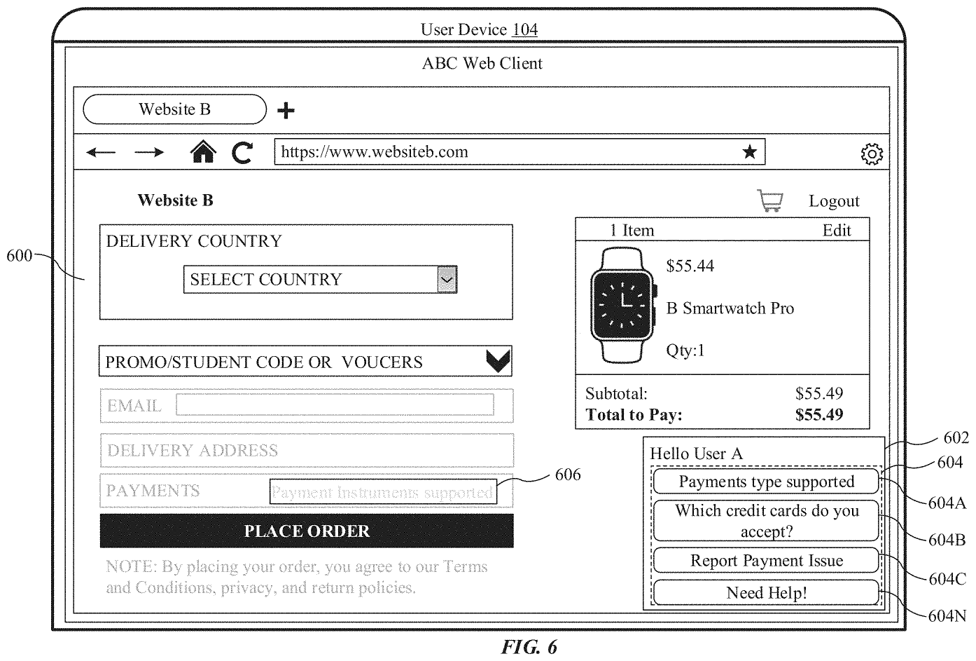

The system 102 may be further configured to select one or more rules to be applied on the generated context table. Such rules may be stored in a rule database 206 that may be hosted on the server 106. The rule database 206 may be configured to store a plurality of rules that can be applied to elements of the context table to search the catalog of action items. In an embodiment, the one or more rules may be selected based on a type of each attribute of the determined set of attributes and may be applicable to only one row of the context table at a time. Such rules may be composed by a provider (or an administrator) of the website or the web application. Details about the composition of the one or more rules are provided, for example, in FIG. 6.

The system 102 may be further configured to generate a search query based on the selected one or more rules and the elements of the context table. For example, a first search query associated with a first row of the context table (i.e. Table 1) may be “PRODUCT_URL=phone-12-pro and LOCATION=USA”. A second search query associated with a third row may be “PRODUCT_URL=companyA-tv-4k and SECTION_PAGE=specs and LOCATION=USA”. The system 102 may search the catalog of action items using the generated search query to determine the set of action items 210.

In an embodiment, the set of action items 210 may correspond to one or more of a call-to-action (CTA) associated with the product or the service, a greeting, a reminder, an active ticket or a service request, a catalog item, a knowledge base article, a call request option, a search bar, a case management guide, and a chat option to initiate a chat with a support member. Each action item of the set of action items 210 may be clickable and contextually related to a product or a service offered by the website or the web application.

As a first example, if the end-user visits the URL “https://www.companyA.com/phone-12-pro/”, then the set of action items 210 may include a first action item 210A to chat with an expert (with a caption “Chat with an expert about phone12 pro”), a second action item 210B to book a visit to the nearest store (with a caption “Visit your nearest store”), and a third action item 210C to raise a service request (with a caption “Facing an issue with phone 12 pro”). As another example, if the end-user visits the URL “https://www.companyA.com/companyA-tv-4k/specs/”, then the set of action items 210 may include a fourth action item to chat with an expert (with a caption “Chat with an expert about companyA TV 4K”), a fifth action item to find help with a subscription (with a caption “Looking to Subscribe to TV+ subscription”), and a sixth first action item to lookup a specification of 4K TV (with a caption “Need help with companyA TV 4K specifications”).

Each action item of the determined set of action items 210 may be clickable and contextually related to the product or the service offered by the website or the web application. With reference to example 1 and Table 1, each of the determined set of action items 210 may be related to “phone 12 pro”. Phone 12 pro may be a product offered for sale or advertised (i.e. a service) on the website with URL “https://www.companyA.com/phone-12-pro/”.

At 202D, an engagement UI rendering operation may be executed. In the engagement UI rendering, the system 102 may be configured to control the web client of the user device 104 to render the engagement UI 208 on the page 204. The system 102 may be further configured to control the web client of the user device 104 to present the determined set of action items 210 items as UI elements of the engagement UI 208.

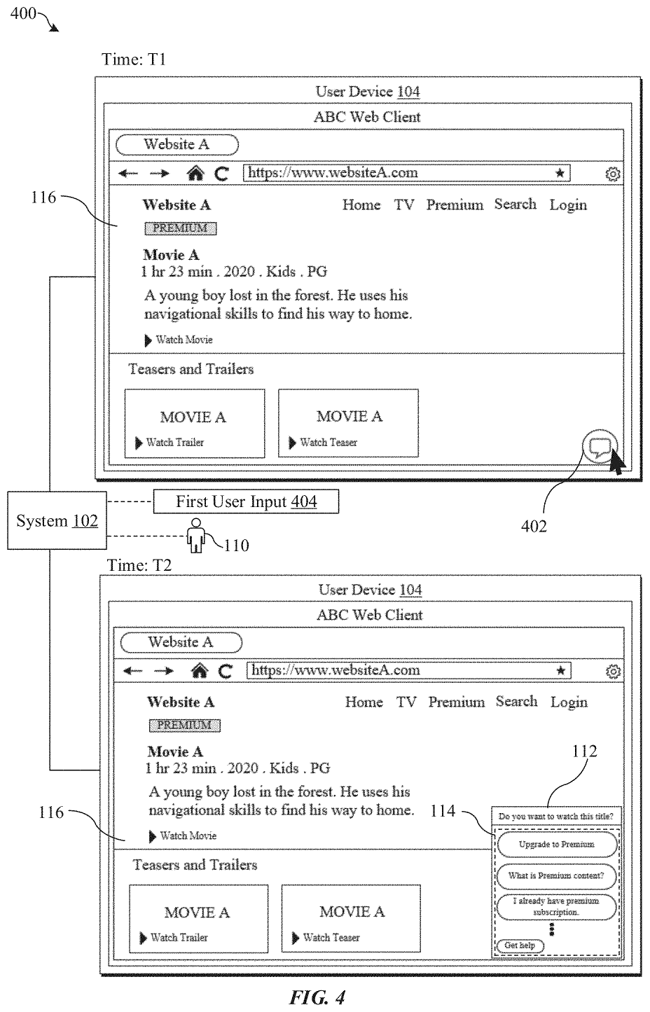

In an embodiment, the system 102 may be further configured to control the web client to overlay an option 212 to view the engagement UI 208 as an overlay item on the page 204. At any time-instant, the system 102 may be configured to receive a first user input to select the overlaid option 212. The engagement UI 208 may be rendered on the the first user input are provided, for example, in FIG. 4.

In an embodiment, the system 102 may be configured to receive a second user input via the rendered engagement UI 208. The second user input may include a selection of the first action item 210A of the presented set of action items 210. Based on the reception of the second user input, the system 102 may be configured to control the web client on the user device 104 to display at least one of details of the product or the service, a greeting, a reminder, an active ticket or a service request, a catalog item, a knowledge base article, a panel to call a support team member, a search bar, a case management guide, or a chat option to initiate a chat with a support member.

With reference to Table 1, if the second user input includes a selection of the first action item 210A, i.e., “Chat with an expert about phone 12 pro”, then the system 102 may be configured to display the chat option or a chat window to initiate the chat with the support member about the phone 12 pro.

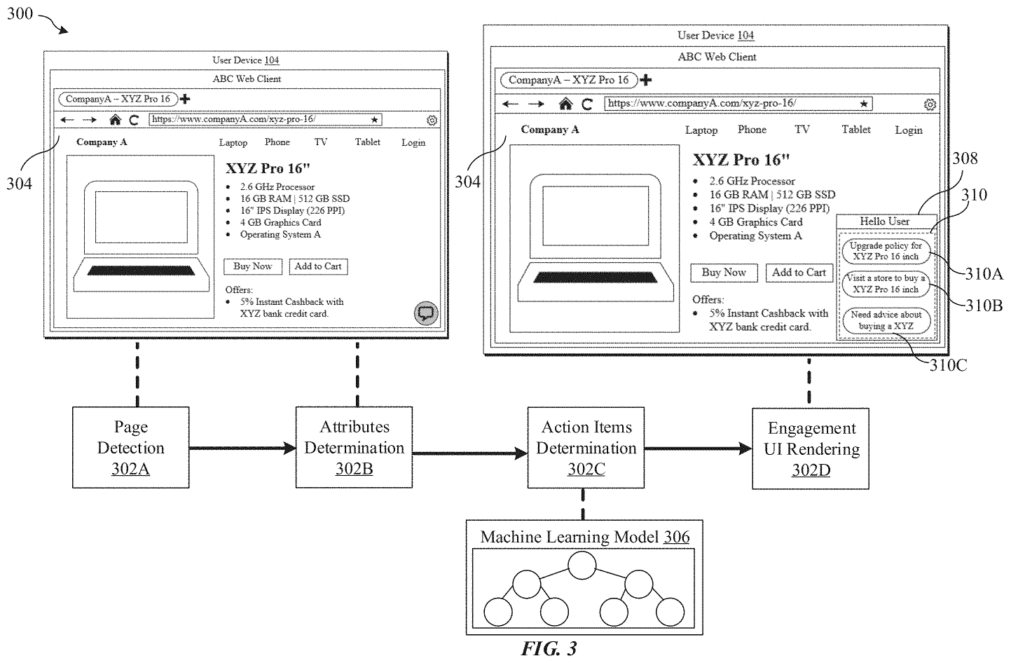

FIG. 3 is a block diagram that illustrates a second set of operations for rendering of engagement UI for pages accessed using web clients, in accordance with an embodiment of the disclosure. FIG. 3 is explained in conjunction with elements from FIG. 1, and FIG. 2. With reference to FIG. 3, there is shown a block diagram 300 of a set of exemplary operations from 302A to 302D. The exemplary operations illustrated in the block diagram 300 may be performed by any system, such as by the system 102 of FIG. 1 or by a processor 802 of FIG. 8.

At 302A, a page detection operation may be executed. In the page detection operation, the system 102 may be configured to detect a page 304 of the website or the web application as active or loaded within the web client of the user device 104. Details about the detection of the page 304 as active or loaded within the web client of the user device 104 are provided, for example, in FIG. 1 and FIG. 2.

At 302B, an attribute determination operation may be executed. In the attributes determination operation, the system 102 may be configured to determine a set of attributes associated with the detected page 304, as described in FIG. 1 and FIG. 3. The set of attributes may be embedded into the page 304 and may include a URL of the page 304, a title of the page 304, a heading of the page 304, a set of HTML tags of the page 304, and one or more user-defined custom attributes. Additionally, the set of attributes may be associated with the web client and may include a geo-location of the end-user 110 accessing the page 304 through the web client of the user device 104 and a browsing history on the web client or one or more web clients installed on the user device 104,

At 302C, an action items determination operation may be executed. In the action items determination operation, the system 102 may be configured to determine a set of action items 310 to be rendered on an engagement UI 308. To determine the set of action items 310, the system 102 may be configured to search a catalog of action items that may be stored on the server 106. The catalog of action items may be searched based on the determined set of attributes.

The search may include application of a machine learning (ML) model 306 on the determined set of attributes. The ML model 306 may be applied on the determined set of attributes to search the catalog of action items and to determine the set of action items from catalog.

In some embodiments, the ML model 306 may be different from a neural network model. For example, the ML model 306 may be based on one of or an ensemble of: a decision tree, a random forest, a Naive Bayes, and a support vector machine. In these or other embodiments, the ML model 306 may implement a meta-heuristic search that may use a type of stochastic optimization.

In some other embodiments, the ML model 306 may be a computational network or a system of artificial neurons (referred to as nodes), arranged in a plurality of layers. The plurality of layers of the ML model 306 may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs to each hidden layer may be coupled to outputs of at least one node in other layers of the ML model 306. Outputs of each hidden layer may be coupled to inputs of at least one node in other layers of the ML model 306. Node(s) in the final layer may receive inputs from at least one hidden layer to output a result. The number of layers and the number of nodes in each layer may be determined from hyper-parameters of the ML model 306. Such hyper-parameters may be set before, while training, or after training the ML model 306 on a training dataset.

Each node of the ML model 306 may correspond to a mathematical function (e.g., a sigmoid function or a rectified linear unit) with a set of parameters, tunable during training of the ML model 306. The set of parameters may include, for example, a weight parameter, a regularization parameter, and the like. Each node may use the mathematical function to compute an output based on one or more inputs from nodes in other layer(s) (e.g., previous layer(s)) of the ML model 306. All or some of the nodes of the ML model 306 may correspond to same or a different mathematical function.

In training of the ML model 306, one or more parameters of each node of the ML model 306 may be updated based on whether an output of the final layer for a given input (from the training dataset) matches a correct result based on a loss function for the ML model 306. The above process may be repeated for same or a different input till a minima of loss function may be achieved, and a training error is minimized. Several methods for training are known in art, for example, gradient descent, stochastic gradient descent, batch gradient descent, gradient boost, meta-heuristics, and the like.

The ML model 306 may include electronic data, which may be implemented as, for example, a software component of an application executable on the system 102. The ML model 306 may rely on libraries, external scripts, or other logic/instructions for execution by a processing device, such as a processor of the system 102. The ML model 306 may include code and routines configured to enable a computing device, such as the system 102 to perform one or more operations for searching the catalog of action items and determination of the set of action items. Additionally, or alternatively, the ML model 306 may be implemented using hardware, including a processor, a microprocessor (e.g., to perform or control performance of one or more operations), a co-processor (such as an Artificial Intelligence (AI) accelerator), a field-programmable gate array (FPGA), or an application-specific integrated circuit (ASIC). Alternatively, in some embodiments, the ML model 306 may be implemented using a combination of hardware and software. Examples of the ML model 306 may include, but are not limited to, a deep neural network (DNN), an artificial neural network (ANN) for search, and/or a combination of such networks.

To search the catalog of action items, the system 102 may be configured to determine one or more first keywords that may be associated with content rendered on the page 304 and a browsing history on the web client. Each of the determined one or more first keywords may be same as or semantically similar to other keywords of the determined one or more first keywords. As an example, a first keyword of the one or more first keywords may be same as or semantically similar to a second keyword of the one or more first keywords. For example, if the first keyword is “XYZ Pro 16 inch” (a laptop of XYZ brand), then the second keyword may be “XYZ Laptops”, “XYZ”, or “XYZ Pro 13 inch” (another model of laptop from XYZ brand).

In an embodiment, the system 102 may be configured to determine the content rendered on the page 304 to determine the first keyword of the one or more first keywords. In another embodiment, the first keyword may be determined based on the URL (e.g., Product URL) of the page 304. In another embodiment, the system 102 may be further configured to analyze the browsing history associated with the web client. Based on the analysis, the system 102 may determine a set of keywords from the browsing history. Such keywords may be determined to be same as the first keyword or may be semantically similar to the first keyword. For example, if the content rendered on the page 304 is associated with a laptop (XYZ Pro 16 inch), then the first keyword may be “XYZ Pro 16 inch”. The browsing history may be associated with one or more searches related to “Company A” laptops, such as “XYZ”, “XYZ Air”, and “XYZ Pro 13 inch”. The set of keywords may include a second keyword as “XYZ”. The determined one or more first keywords may include the first keyword as “XYZ Pro 16” and the second keyword as “XYZ”.

The system 102 may be configured to associate a first weight with each of the determined one or more first keywords. In an embodiment, the first weight may be associated based on a frequency of occurrence of a corresponding keyword in the browsing history over a pre-defined period of time. For example, if a particular keyword is present ‘x’ times in the browsing history of a ‘y’ period, then the first weight to be associated with the keyword may be ‘z’. In another embodiment, the first weight to be associated with a keyword determined from content rendered on the page may be greater than the first weight to be associated each of the set of keywords determined from the browsing history on the web client. As an example, the first weight associated with “XYZ Pro 16” may be 70% and the first weight associated with “XYZ” may be 30%.

In an embodiment, the system 102 may provide the determined one or more first keywords, the first weight associated with each of the one or more first keywords, and the catalog of action items as an input to the ML model 306. The system 102 may determine the set of action items 310 based on the application of the ML model 306 on the input. Specifically, the ML model 306 may perform a search using the one or more first keywords and the weights associated with the keywords within the catalog of action items. The ML model 306 may provide an output based on the input. The output may be referred to as a result of the search and may include the set of action items. As an example, the set of action items may include a first action item 310A about an option to upgrade the laptop with a caption “Upgrade policy for XYZ Pro 16 inch”, a second action item 310B about booking a store visit with a caption “Visit a store to buy a XYZ Pro 16 inch”, and a third action item 310C about seeking advice on purchase with a caption “Need advice about buying a XYZ”.

In an embodiment, the system 102 may determine the first keyword with a maximum first weight from among the one or more first keywords. The set of action items for presentation on the engagement UI may be determined further based on the determined first keyword. For example, if the first keyword is “XYZ Pro 13 inch”, then the set of action items may include the first action item 310A about an option to upgrade the laptop with a caption “Upgrade policy for XYZ Pro 13 inch”, a second action item 310B about booking a store visit with a caption “Visit a store to buy a XYZ Pro 13 inch”, and a third action item 310C about seeking advice on purchase with a caption “Need advice about buying a XYZ”.

In an embodiment, the system 102 may be configured to determine one or more second keywords associated with one or more of: content rendered on the page, a uniform resource locator (URL) of the page, a title of the page, or a heading of the page. Specifically, the one or more second keywords may be present in one or more of the URL of the page, the title of the page, and/or the heading of the page. The system 102 may be further configured to associate a second weight with each of the determined one or more second keywords. The ML model 306 may be applied on the one or more second keywords and the second weight associated with each of the one or more second keywords to determine the set of action items.

In an embodiment, the determined one or more second keywords may include a first keyword, a second keyword, a third keyword, and a fourth keyword. The first keyword may be associated with the content rendered on the page. The second keyword may be associated with the URL of the page. The third keyword may be associated with the title of the page and the fourth keyword may be associated with the heading of the page. The system 102 may be configured to apply a first set of rules in a sequential order to associate the second weight with each of the determined one or more second keywords. In an embodiment, the first set of rules may include a first rule, a second rule, a third rule, a fourth rule, a fifth rule that may be applied in the sequential order. As an example, the first rule may be that the second weight to be associated with the first keyword should be 70% of a total weight and the second weight associated with the second keyword (or the third keyword and the fourth keyword) should be 30% of the total weight, if the second keyword, the third keyword, and the fourth keyword are same or the URL of the page, the title of the page, and the heading of the page have common keywords.

The second rule may be that the second weight associated with the first keyword should be 70% of the total weight and the second weight associated with the second keyword (or the fourth keyword) should be 30% of the total weight, if the second keyword and the fourth keyword are same or the URL of the page and the heading of the page have common keywords.

The third rule may be that the second weight associated with the first keyword should be 70% of the total weight and the second weight associated with the third keyword (or the fourth keyword) should be 30% of the total weight, if the third keyword and the fourth keyword are same or the title of the page and the heading of the page have common keywords. The fourth rule may be that the second weight associated with the first keyword should be 70% of the total weight and the second weight associated with the second keyword should be 30% of the total weight, if the fourth keyword is undefined or the title of the page is not present. The fifth rule may be applied after the application of the first rule, the second rule, the third rule, and the fourth rule. The fifth rule may be that the second weight associated with the second keyword should be 100% of the total weight.

The system 102 may be further configured to determine the set of action items 310 based on the determined one or more second keywords and the second weight associated with each of the one or more second keywords. In an embodiment, the ML model 306 may be applied on the determined one or more second keywords and the second weight associated with each of the one or more second keywords to determine the set of action items 310. Details about the set of action items are provided, for example, in FIG. 2.

At 302D, an engagement UI rendering operation may be executed. In the engagement UI rendering, the system 102 may be configured to control the web client of the user device 104 to render an engagement UI 308 on the page 304 and present the determined set of action items 310 as UI elements of the engagement UI 308. The engagement UI 308 may be rendered as an overlay on the content of the page 304.

FIG. 4 is a diagram that illustrates an exemplary scenario for rendering of an option to view engagement UI for pages accessed using web clients, in accordance with an embodiment of the disclosure. FIG. 4 is explained in conjunction with elements from FIG. 1, FIG. 2, and FIG. 3. With reference to FIG. 4, there is shown an exemplary scenario 400. In the exemplary scenario 400, there is shown the system 102 and the user device 104 associated with the system 102. The system 102 may control the user device 104 to display the page 116 of the website or the web application. With reference to FIG. 4, there is further shown the end-user 110 associated with the user device 104 and an option 402 on the page 116 of the website or the web application.

At time T₁, the system 102 may detect the page 116 of the website or the web application as active or loaded within the web client of the user device 104. Based on the detection of the page 116 of the website or the web application as active or loaded, the system 102 may be configured to control the web client to overlay the option 402 to view the engagement UI as an overlay item on the page 116. The overlaid option 402 may correspond to a UI element that may be overlaid on the page 116 and may be clickable. Based on the selection of the overlaid option 402, the system 102 may be configured to control the web client of the user device 104 to render the engagement UI 112 on the page 116.

In an embodiment, the overlay option 402 may be a launcher icon, a button, a URL (text-based hyperlink), or a parameterized URL. The parameterized URL may include one or more parameters that may be passed to the page 116 from a source. For example, the one or more parameters may be passed via a JavaScript Function. Examples of one or more parameters may include, but are limited to, a Knowledge article parameter, a latest case parameter, a new case parameter, a catalog parameter, a search parameter, a chat parameter, a new appointment booking parameter, and a view next appointment booking parameter. The knowledge article parameter may correspond to a knowledge article identifier. The latest case parameter may correspond to a current case (or service request) on which the end user may have previously worked. An example of the parameterized URL may be an email that may be sent to a particular customer about an update in a complaint raised by him/her. When the user clicks on a button present in the email, the system 102 may control the web client on the user device 104 to load the page 116 and render the engagement UI 112 on the loaded page 116.

In certain scenarios, the determination of the set of action items may be triggered only after the overlaid option 402 is selected. In such scenarios, the system 102 may receive a first user input 404. The first user input 404 may correspond to selection the overlaid option 402. Based on the reception of the first user input 404, the system 102 may determine the set of attributes associated with the detected page 116 and may search the catalog of actions items based on the determined set of attributes. Based on the search, the system 102 may determine the set of actions items 114. In certain scenarios, the determination of the set of action items may be triggered as soon as the page 116 is detected as loaded or active in the web client. In such scenarios, the system 102 may be configured to determine the set of actions items 114 based on the detection of the page 116 of the website or the web application as active or loaded within the web client of the user device 104, as described in FIG. 2 and FIG. 3.

At time T2, the system 102 may control the web client of the user device 104 to render the engagement UI 112 on the page 116, based on the received first user input 404. Thereafter, the system 102 may control the web client of the user device 104 to present the determined set of actions items as the UI elements of the engagement UI 112.

In another embodiment, the system 102 may be configured to proactively control the web client of the user device 104 to render the engagement UI 112 on the page 116. In such an embodiment, the system 102 may determine a duration for which the page 116 may have been loaded or may have been active on the web client of the user device 104. The system 102 may be further configured to compare the determined duration with a threshold. In case the determined duration is greater than or equal to the threshold, the system 102 may be configured to control the web client of the user device 104 to render the engagement UI 112 on the page 116 and to present the determined set of actions items 114 as the UI elements of the engagement UI 112. The determined set of actions items 114 may include, for example, a search bar and a chat option to initiate a chat with a support member. In another embodiment, the system 102 may be configured to control the web client of the user device 104 to render one or more animations on the overlaid option 402 before rendering the engagement UI 112.

The engagement UI 112 may be rendered to assist the end-user 110 on issues or queries that the end-user 110 may have in relation to a product or a service offered by the website or the web application. By providing support for the relevant queries or the issues according to attributes/context of the pages, the customer churn for the website or web application may reduce over time. Such reduction may help to increase an overall revenue for products/services offered or advertised on the website/web application.

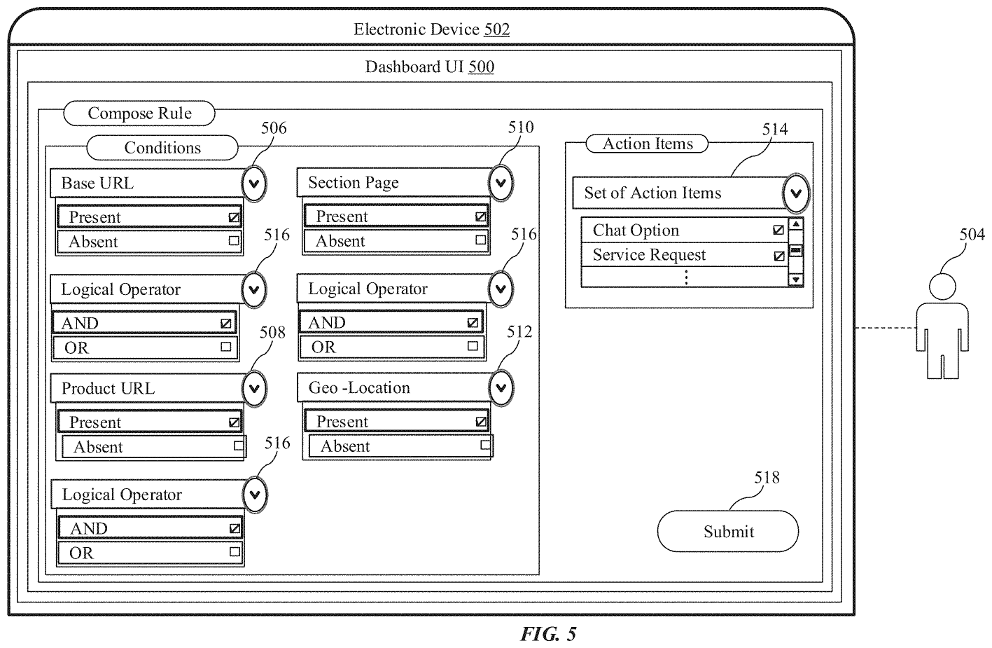

FIG. 5 is a diagram that illustrates an example dashboard user interface for composing one or more rules for determination of a set of action items, in accordance with an embodiment of the disclosure. FIG. 5 is explained in conjunction with elements from FIG. 1, FIG. 2, FIG. 3, and FIG. 4. With reference to FIG. 5, there is shown a dashboard user interface (UI) 500. The dashboard UI 500 may be displayed on a display screen of an electronic device 502 based on an admin request, which may be received from a provider 504 of the website or the web application via an application interface. The provider 504 of the website or the web application may be an owner or an administrator of the website or the web application.

The system 102 may be configured to receive the admin request for composition of the one or more rules from the provider 504 of the website or the web application. Based on the reception of the admin request, the system 102 may be configured to control the electronic device 502 associated with the provider 504 of the website or the web application to render the dashboard UI 500.

In an embodiment, the dashboard UI 500, may include a first UI element 506, a second UI element 508, a third UI element 510, a fourth UI element 512, a fifth UI element 514, a sixth UI element 516, and a seventh UI element 518. In FIG. 6, the first UI element 506 may be labeled as, for example, “Base URL” and may be a dropdown list with two options i.e. “Present” and “Absent”. The second UI element 508 may be labeled as, for example, “Product URL” and may be a dropdown list with two options i.e. “Present” and “Absent”. The third UI element 510 may be labeled as, for example, “Section Page” and may be a dropdown list with two options i.e. “Present” and “Absent”. The fourth UI element 512 may be labeled as, for example, “Geo Location” and may be a dropdown list with two options i.e. “Present” or “Absent”. The fifth UI element 514 may be labeled as, for example, “Set of Actions” and may be a dropdown list with the catalog of action items. The sixth UI element 516 may be labeled as, for example, “Logical Operators” and may be a dropdown list with options such as “AND”, “NOT”, and “OR”. The sixth UI element 516 may be used to add a logical operator between one or more of the first UI element 506 and the second UI element 508, the second UI element 508 and the third UI element 510, and the third UI element 510 and the fourth UI element 512. In an embodiment, the first UI element 506 and the second UI element 508 to add the logical operator between the first UI element 506 and the second UI element 508. Similarly, the sixth UI element 516 may be placed between the second UI element 508 and the third UI element 510, and the third UI element 510 and the fourth UI element 512. The seventh UI element 518 may be labeled as “Submit” and may be a button.

The system 102 may be configured to receive an admin input for composition of one or more rules to be used for the search. The admin input may be received via the dashboard UI 500 and may correspond to selection of either “Present” or “Absent” options for the “Base URL”, “Product URL”, “Section Page”, “Geo Location”, “Set of Actions”, and “Logical Operators” via the first UI element 506, the second UI element 508, the third UI element 510, the fourth UI element 512, the fifth UI element 514, and the sixth UI element 516, respectively.

Based on the received admin input, the system 102 may be configured to compose the one or more rules. With reference to Table 1 of FIG. 1, if the values for “Base URL”, “Product URL”, “Section Page”, and “Geo Location” are present, then the set of actions may include a chat option to initiate a chat with a support member, a service request, and a knowledge base article. Each of the set of options may be contextually associated with a product mentioned in the “Product URL”. As another example, if the values for “Base URL”, “Product URL”, and “Geo Location” are present, then the set of actions may include a chat option to initiate a chat with a support member, a call-to-action (CTA) associated with the product or the service, and a service request associated with the product(s)/service(s) specified in the “Product URL”. The system 102 may be further configured to store the composed one or more rules in the rule database 206. In an embodiment, the rule database 206 may be further stored on the server 106.

FIG. 6 is a diagram that illustrates an exemplary engagement UI on a payment page of exemplary electronic commerce (e-commerce) website, in accordance with an embodiment of the disclosure. FIG. 6 is explained in conjunction with elements from FIG. 1, FIG. 2, FIG. 3, FIG. 4, and FIG. 5. With reference to FIG. 6, there is shown a payments page 600. The payments page 600 may be displayed within a web client of a user device 104 based on a user request. There is further shown an engagement UI 602 that includes a set of action items 604.

In an embodiment, the system 102 may be configured to detect the payments page 600 of the exemplary e-commerce website with URL as “https://www.websiteB.com” as active or loaded within the web client (such as an ABC web browser) of the user device 104. The system 102 may be configured to determine a set of attributes that may be embedded into the detected payments page 600. In an embodiment, the set of attributes may include the URL of the payments page 600, a geo-location of the end-user 110 accessing the payments page 600 through the web client of the user device 104, a title of the payments page 600, a heading of the payments page 600, a set of Hypertext Markup Language (HTML) tags of the payments page 600, and one or more user-defined custom attributes. Additionally, the set of attributes may include a browsing history on the web client.

The system 102 may be configured to search a catalog of actions items based on the determined set of attributes to determine the set of actions items 604. In an embodiment, the system 102 may be configured to search the catalog of actions items and determine the set of action items 604 using a rule-based approach as described in FIG. 2. In another embodiment, the system 102 may apply ML model on the determined set of attributes to search the catalogue of action items and to determine the set of actions items 604 as described in FIG. 3. The set of action items may include a first action item 604A, a second action item 604B, a third action item 604C, and an Nth action item 604N. Each action item of the set of action items may be clickable and may be contextually related to a payment service supported by the exemplary e-commerce website. The set of action items correspond to one or more of a call-to-action (CTA) associated with the product or the service, a greeting, a reminder, an active ticket or a service request, a catalog item, a knowledge base article, a call request option, a search bar, a case management guide, and a chat option to initiate a chat with a support member. Details about the determination of the set of action items 604 are provided, for example, in FIG. 3 and FIG. 4.

By way of example, and not limitation, the first action item 604A and the second action item 604B may correspond to a knowledge base article. The third action item 604C may correspond to a case management guide and the Nth action item 604N may correspond to a chat option to initiate a chat with a support member.

The system 102 may be further configured to control the web client of the user device 104 to render the engagement UI 602 on the payments page 600. The system 102 may be configured to further control the web client of the user device 104 to present the determined set of actions items 604 items as UI elements of the engagement UI 602.

In an embodiment, the system 102 may receive the second user input via the rendered engagement UI 602. The received second user input may include a selection of the first action item 604A of the presented set of action items 604. The system 102 may further control the web client on the user device 104 based on the received second user input to display the knowledge base article associated with different types of payments that may be supported by the exemplary e-commerce website. In another embodiment, the system 102 may receive a third user input via the rendered engagement UI 602. The received third user input may include selection of the Nth action item 604N of the presented set of action items 604. The system 102 may further control the web client on the user device 104 based on the received third user input to display the chat option to initiate the chat with the support member.

With reference to FIG. 6, there is further shown a UI element 606. The UI element 606 may be a hyperlink with following linked text: “Payments Instruments Supported”. In an embodiment, the system 102 may be configured to receive a fourth user input corresponding to the selection of the UI element 606. Based on the selection of the UI element 606, the system 102 may be configured to determine the set of action items and control the web client on the user device 104 to render the engagement UI 602 on the payments page 600 and present the determined set of action items 604 items as UI elements of the engagement UI 602.

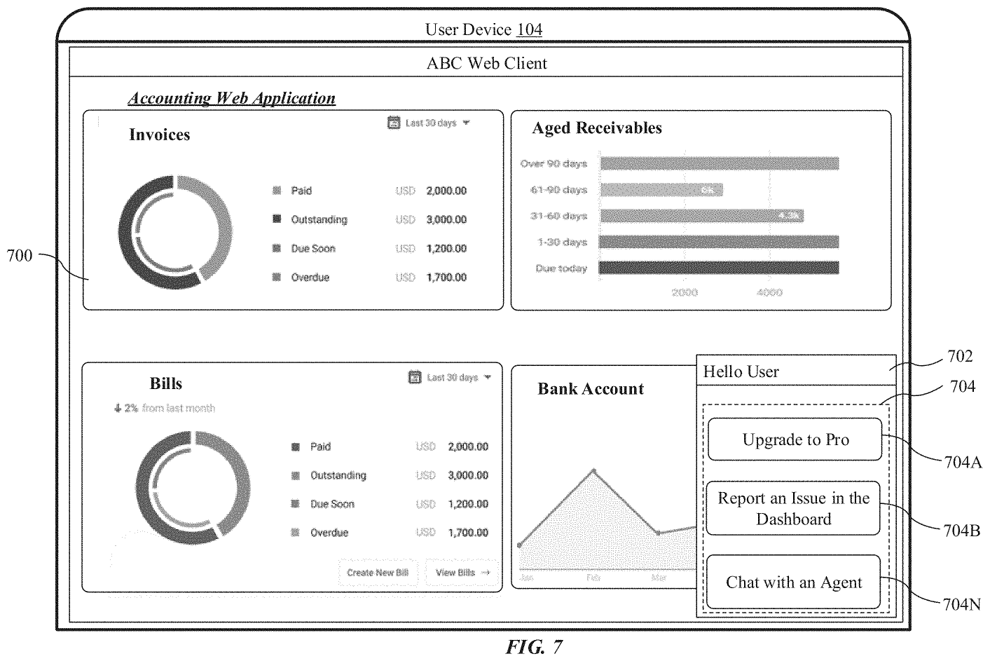

FIG. 7 is a diagram that illustrates an exemplary engagement UI on a page of exemplary accounting web application, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown a page 700. The page 700 may be displayed within a web client of a user device 104 based on a user request. There is further shown an engagement UI 702 that may include a set of action items 704.

In an embodiment, the system 102 may be configured to detect the page 700 of the exemplary accounting web application as active or loaded within the web client (say ABC web client) of the user device 104. The system 102 may be configured to determine a set of attributes that may be embedded in the detected page 700 and to search a catalog of actions items based on the determined set of attributes so as to determine the set of actions items 704. Details about the determination of the set of action items 704 are provided, for example, in FIG. 3 and FIG. 4.

The set of action items 704 may include a first action item 704A, a second action item 704B, and an Nth action item 704N. Each action item of the set of action items 704 may be clickable and may be contextually related to one or more services offered by the exemplary accounting web application. By way of example, and not limitation, the first action item 704A may correspond to a catalog item (with a caption “Upgrade to Pro”). The second action item 704B may correspond to a service request (with a caption “Report an Issue in the Dashboard”) and the Nth action item 704N may correspond to a chat option to initiate a chat with a support member (with a caption “Chat with an Agent”).

The system 102 may be further configured to control the web client of the user device 104 to render the engagement UI 702 on the detected page 700. The web client may be further controlled to present the determined set of action items 704 items as UI elements of the engagement UI 702.

It should be noted that the exemplary e-commerce website and the exemplary accounting web application in FIG. 6 and FIG. 7 are merely provided as examples and should not be construed as limiting the disclosure. The present disclosure may be applicable to other types of websites and web applications related to Finance, banking, telecom, energy production, healthcare, government or citizen portals, reservations, navigation, machine learning bases applications, and education, without a deviation from the scope of the disclosure.

For example, in a finance related website or web application, the set of actions may correspond to the knowledge-based articles such as “How to invest in stocks?”, “How to increase your wealth” etc. In the finance related website or web application, the set of actions may correspond to a chat option to initiate a chat with a finance advisor. Similarly, in case of telecom, the set of actions may correspond to the catalog item such as “Change tariff plan”, an active ticket such as “Our response to your query”, and a chat option to initiate a chat with the support member. In case of healthcare, the set of actions may correspond to the knowledge based articles such as “Why should you have regular body check-ups”, a call-to-action (CTA) such as “Book an appointment for full body check-up”, and a case management guide such as “Not able to purchase a test”. As another example in case of government or citizen portals, the set of actions may include a chat option to initiate a chat with the support member, the search bar to search about particular information, and the knowledge-based articles such as “How to Sign up?”. The description about all these action items for different websites or web applications have been omitted for the sake of brevity.

FIG. 8 is a block diagram of a system for rendering of engagement UI for pages accessed using web clients, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown a block diagram 800 of the system 102. The system 102 may processor 802, a memory 804, an input/output (I/O) device 806, a network interface 808, and the ML model 306.

The processor 802 may include suitable logic, circuitry, interfaces, and/or code that may be configured to execute instructions for operations to be executed by the system 102 to render the engagement UI 112 for the pages accessed using web clients. Example implementations of the processor 802 may include, but are not limited to, a Central Processing Unit (CPU), x86-based processor, a Reduced Instruction Set Computing (RISC) processor, an Application-Specific Integrated Circuit (ASIC) processor, a Complex Instruction Set Computing (CISC) processor, a Graphical Processing Unit (GPU), co-processors, other processors, and/or a combination thereof.

The memory 804 may include suitable logic, circuitry, code, and/or interfaces that may be configured to store the instructions executable by the processor 802. For instance, the memory 804 may store the received first user input, the received second user input, the context tables, the rule database 206, and the ML model 306. The memory 804 may be further configured to store the determined set of attributes, the catalog of search items, and the determined set of action items 114. Examples of implementation of the memory 804 may include, but are not limited to, Random Access Memory (RAM), Read Only Memory (ROM), Hard Disk Drive (HDD), and/or a Secure Digital (SD) card.

The I/O device 806 may include suitable logic, circuitry, and/or interfaces that may be configured to receive one or more inputs and provide an output based on the received one or more inputs. The first user input and the second user input may be received via the I/O device 806. The I/O device 806 may include various input and output devices, which may be configured to communicate with the processor 802. Examples of the I/O device 806 may include, but are not limited to, a touch screen, a keyboard, a mouse, a joystick, a display device, a microphone, or a speaker.

The network interface 808 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 808 may communicate via wireless communication with networks, such as the Internet, an Intranet, and/or a wireless network, such as a cellular telephone network, a wireless local area network (LAN) and/or a metropolitan area network (MAN). The wireless communication may use any of a plurality of communication standards, protocols and technologies, such as Long Term Evolution (LTE), Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.120 g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The functions or operations executed by the system 102, as described in FIGS. 1, 2, 3, 4, 5, 6, 7, and 9 may be performed by the processor 802.

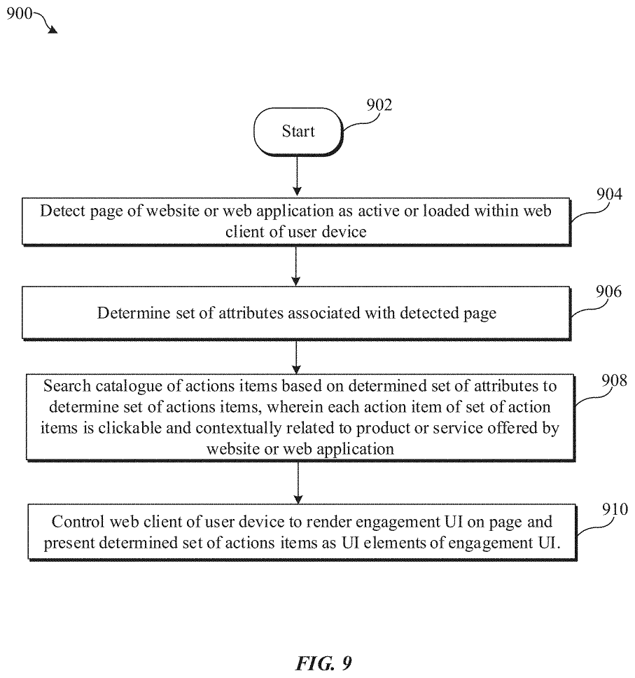

FIG. 9 is a flowchart that illustrates an exemplary method for rendering of engagement UI for pages accessed using web clients, in accordance with an embodiment of the disclosure. FIG. 9 is described in conjunction with elements from FIGS. 1, 2, 3,4, 5, 6, 7, and 8. With reference to FIG. 9, there is shown a flowchart 900. The exemplary method of the flowchart 900 may be executed by any system, for example, by the system 102 of FIG. 1 or the processor 802 of FIG. 8. The exemplary method of the flowchart 900 may start at 902 and proceed to 904.

At 904, the page 116 of the website or the web application may be detected as active or loaded within the web client of the user device 104. In one or more embodiments, the system 102 may be configured to detect the page 116 of the website or the web application as active or loaded within the web client of the user device 104. The details about the detection of the page are provided, for example, in FIG. 1 and FIG. 2.

At 906, the set of attributes associated with the detected page 116 may be determined. In one or more embodiments, the system 102 may be configured to determine the set of attributes associated with the detected page 116. The details about the determination of the set of attributes are provided, for example, in FIG. 1 and FIG. 2.

At 908, the catalog of actions items may be searched to determine the set of action items 114. The catalog of actions items may be searched based on the determined set of attributes. Each action item of the set of action items 114 may clickable and contextually related to the product or the service offered by the website or the web application. In one or more embodiments, the system 102 may be configured to search the catalog of actions items based on the determined set of attributes to determine the set of actions items 114, wherein each action item of the set of action items 114 may be clickable and contextually related to the product or the service offered by the website or the web application. The details about the determination of the set of actions items, for example, in FIG. 2 and FIG. 3.

At 910, the web client of the user device 104 may be controlled. The web client of the user device 104 may be controlled to render the engagement UI 112 on the page 116 and to present the determined set of action item0073 114 items as UI elements of the engagement UI 112. In one or more embodiments, the system 102 may be configured to control the web client of the user device 104 to render the engagement UI 112 on the page 116 and to present the determined set of actions items 114 as UI elements of the engagement UI 112. The details about rendering the engagement UI 112 are provided, for example, in FIG. 4, FIG. 6, and FIG. 7. Control may pass to end.

Although the flowchart 900 is illustrated as discrete operations, such as 902, 904, 906, 908, and 910 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer-executable instructions executable by a machine and/or a computer to operate a system (e.g., the system 102) for rendering of engagement UI for pages accessed using web clients. The computer-executable instructions may cause the machine and/or computer to perform operations that may include detection of a page (e.g., the page 116) of a website or a web application as active or loaded within a web client of a user device (e.g., the user device 104). The operations further include determination of a set of attributes associated with the detected page. The operations further include searching a catalog of actions items based on the determined set of attributes to determine a set of actions items (e.g., the set of actions items 114). Each action item of the set of action items may be clickable and contextually related to a product or a service offered by the website or the web application. The operations further include controlling the web client of the user device to render an engagement UI (e.g., the engagement UI 112) on the page and to present the determined set of actions items as UI elements of the engagement UI.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively, or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long-term storage, like ROM, optical or magnetic disks, solid state drives, compact disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures. While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

1. A method, comprising:
transmitting a request to a web client of a user device for the web client to determine whether a page of a website or a web application is active or loaded;
determining a set of attributes associated with the page;
searching a catalog of action items based on the determined set of attributes to determine a set of action items, wherein each action item of the set of action items is clickable and contextually related to a product or a service offered by the website or the web application; and
controlling the web client of the user device to: render an engagement UI on the page, and present the determined set of action items as UI elements of the engagement UI.

2. The method according to claim 1, wherein the set of attributes is embedded into the page and comprises at least one of: a uniform resource locator (URL) of the page, a geo-location of an end-user accessing the page through the web client of the user device, a browsing history on the web client, a title of the page, a heading of the page, a set of Hypertext Markup Language (HTML) tags of the page, or one or more user-defined custom attributes.

3. The method according to claim 1, wherein the set of action items correspond to one or more of: a call-to-action (CTA) associated with the product or the service, a greeting, a reminder, an active ticket or a service request, a catalog item, a knowledge base article, a call request option, a search bar, a case management guide, or a chat option to initiate a chat with a support member.

4. The method according to claim 1, further comprising:
controlling the web client to overlay an option to view the engagement UI as an overlay item on the page; and
receiving a first user input to select the overlaid option, wherein the engagement UI is rendered on the page based on the received first user input.

5. The method according to claim 1, further comprising:
determining a duration for which the page is loaded or is active on the web client of the user device; and
comparing the determined duration with a threshold, wherein the engagement UI is rendered further based on the comparison.

6. The method according to claim 1, further comprising:
receiving, via the rendered engagement UI, a second user input comprising a selection of a first action item of the presented set of action items; and
controlling the web client on the user device, based on the received second user input to display at least one of: details of the product or the service, a greeting, a reminder, an active ticket or a service request, a catalog item, a knowledge base article, a panel to call a support team member, a search bar, a case management guide, or a chat option to initiate a chat with a support member.

7. The method according to claim 1, further comprising:
controlling an electronic device associated with a provider of the website or the web application to render a dashboard UI;
receiving, via the dashboard UI, an admin input for composition of one or more rules to be used for the search;
composing the one or more rules based on the received admin input; and
storing the composed one or more rules in a rule database.

8. The method according to claim 1, further comprising:
generating a context table to include the determined set of attributes;
selecting one or more rules applicable on the context table; and
generating a search query based on the selected one or more rules and elements of the context table, wherein the catalog of action items is searched using the generated search query.

9. The method according to claim 1, wherein the searching comprises applying a machine learning model on the determined set of attributes to search the catalog of action items and to determine the set of action items.

10. The method according to claim 9, further comprising:
determining one or more first keywords associated with content rendered on the page and a browsing history on the web client that is before the page is loaded or is active; and
associating a first weight with each of the determined one or more first keywords, wherein the machine learning model is applied to determine the set of action items, further based on the one or more first keywords and the first weight associated with each of the one or more first keywords.

11. The method according to claim 10, wherein a first keyword of the one or more first keywords is same as or is semantically similar to a second keyword in the one or more first keywords.

12. The method according to claim 10, further comprising:
determining a first keyword with a maximum first weight from the one or more first keywords; and
determining the set of action items for presentation on the engagement UI based on the determined first keyword.

13. The method according to claim 10, further comprising:
determining one or more second keywords associated with one or more of: a uniform resource locator (URL) of the page, a title of the page, or a heading of the page; and
associating a second weight with each of the determined one or more second keywords, wherein the machine learning model is applied to determine the set of action items, further based on the one or more second keywords and the second weight associated with each of the one or more second keywords.

14. A non-transitory computer-readable storage medium configured to store instructions that, in response to being executed, causes a system to perform operations, the operations comprising:
transmitting a request to a web client of a user device for the web client to determine whether a page of a website or a web application is active or loaded;
determining a set of attributes associated with the d-eteGte4 page;
searching a catalog of action items based on the determined set of attributes to determine a set of action items, wherein each action item of the set of action items is clickable and contextually related to a product or a service offered by the website or the web application; and
controlling the web client of the user device to: render an engagement UI on the page, and present the determined set of action items as UI elements of the engagement UI.

15. The non-transitory computer-readable storage medium according to claim 14, wherein the set of attributes is embedded into the page and comprises at least one of: a uniform resource locator (URL) of the page, a geo-location of an end-user accessing the page through the web client of the user device, a browsing history on the web client, a title of the page, a heading of the page, a set of Hypertext Markup Language (HTML) tags of the page, an-GI or one or more user-defined custom attributes.

16. (canceled)

17. The non-transitory computer-readable storage medium according to claim 14, wherein the operations further comprise:
generating a context table to include the determined set of attributes;
selecting one or more rules applicable on the context table; and
generating a search query based on the selected one or more rules and elements of the context table, wherein the catalog of action items is searched using the generated search query.

18. The non-transitory computer-readable storage medium according to claim 14, wherein the search comprises an application of a machine learning model on the determined set of attributes to search the catalog of action items and to determine the set of action items.

19. The non-transitory computer-readable storage medium according to claim 18, wherein the operations further comprise:
determining one or more first keywords associated with content rendered on the page and a browsing history on the web client that is before the page is loaded or is active; and
associating a first weight with each of the determined one or more first keywords, wherein the machine learning model is applied to determine the set of action items, further based on the one or more first keywords and the first weight associated with each of the one or more first keywords.

20. A system, comprising a processor configured to:
transmit a request to a web client of a user device for the web client to determine whether a page of a website or a web application is active or loaded;
determine a set of attributes associated with the page;
search a catalog of action items based on the determined set of attributes to determine a set of actions item, wherein each action item of the set of action items is clickable and contextually related to a product or a service offered by the website or the web application; and
control the web client of the user device to: render an engagement UI on the page, and present the determined set of action items as UI elements of the engagement UI.

21. The method of claim 1, wherein the web client is multi-tabbed, and wherein the page being active or loaded comprises the page being displayed in an active tab of the web client.
